(19) United States
(12) Patent Application Publication
(10) Pub. No.: US 2020/0017032 A1
(43) Pub. Date: Jan. 16, 2020

(54) VEHICLE INTERIOR COMPONENT

(71) Applicant: Shanghai Yanfeng Jinqiao Automotive Trim Systems Co. Ltd., Novi, MI (US)

(72) Inventor: Michael Robert Catlin, Holland, MI (US)

(21) Appl. No.: 16/563,293

(22) Filed: Sep. 6, 2019

Related U.S. Application Data
(63) Continuation of application No. PCT/US19/22079, filed on Mar. 13, 2019.
(60) Provisional application No. 62/642,870, filed on Mar. 14, 2018.

(51) Int. Cl. B60R 7/04; E05F 1/16

(52) U.S. Cl. CPC B60R 7/04; E05F 1/16; E05Y 2201/47; E05Y 2201/41; E05Y 2900/538

(57) ABSTRACT

A component for a vehicle interior is disclosed. The component may comprise a base comprising a compartment and a cover/door assembly moveable between a closed position and an open position through an intermediate/transition position with a force provided by a vehicle occupant. The component may comprise a mechanism configured to facilitate movement of the cover from the open position toward the intermediate position and from the intermediate position into a fully open position. The mechanism may be configured (e.g. designed, tuned, etc.) to provide a braking/restraining/resisting force and/or an assist/lifting/pulling/pushing force to facilitate movement of the cover in a track/guide between open/closed positions through the intermediate position so that operation is within a desired range of force/effort for the occupant. The base and/or door assembly may comprise the mechanism; the mechanism may comprise at least one spring.

### CROSS-REFERENCE TO RELATED APPLICATIONS

The present application is a continuation of International/PCT Patent Application No. PCT/US19/22079 titled “VEHICLE INTERIOR COMPONENT” filed Mar. 13, 2019, which claims the benefit of U.S. Provisional Patent Application No. 62/642,870 titled “VEHICLE INTERIOR COMPONENT” filed Mar. 14, 2018.

The present application claims priority to and incorporates by reference in full the following patent applications: (a) U.S. Provisional Patent Application No. 62/642,870 titled “VEHICLE INTERIOR COMPONENT” filed March 14, 2018; (b) International/PCT Patent Application No. PCT/US19/22079 titled “VEHICLE INTERIOR COMPONENT” filed Mar. 13, 2019.

### FIELD

The present invention relates to a vehicle interior component.

### BACKGROUND

It is known to provide a component for a vehicle interior comprising a base and a cover configured to move relative to the base from an open position to expose a compartment to a closed position to cover the compartment.

It would be advantageous to provide an improved component for a vehicle interior. It would also be advantageous to provide a component comprising a base and a cover/door configured to move relative to the base from an open position to expose a compartment to a closed position to cover the compartment through an intermediate/transition and with a mechanism configured to facilitate movement of the cover/door between the open position the closed position.

### SUMMARY

The present invention relates to a component for a vehicle interior comprising a base comprising a compartment; and a cover configured to move relative to the base in a closing direction from an open position to expose the compartment to a closed position to cover the compartment through an intermediate position. At least one of the cover or the base may comprise a mechanism configured to bias the cover toward the intermediate position when the cover is in the open position. The mechanism may be configured to push the cover in the closing direction. The mechanism may comprise a spring mechanism. The spring mechanism may comprise a coil spring. The cover may comprise a front edge and a rear edge; the mechanism may be configured to push the rear edge of the cover in the closing direction. The cover may be configured to separate from the mechanism as the cover moves from the intermediate position toward the closed position. The cover may comprise a front portion and a rear portion; the front portion of the cover may comprise a tab; the mechanism may be configured to push the tab at the front portion of the cover in the closing direction. The mechanism may comprise a tab and the cover may comprise a tab configured to engage the tab of the mechanism. The base may comprise a structure comprising a first sidewall and a second sidewall to define the compartment and the mechanism may be installed at at least one of the first sidewall and the second sidewall. The mechanism may comprise a tab extending from the at least one of the first sidewall and the second sidewall to engage the cover. The base may comprise a structure comprising a first sidewall and a second sidewall to define the compartment and the mechanism may be installed at at least one of the first sidewall and the second sidewall. The cover may comprise a tab extending into at least one of the first sidewall and the second sidewall to engage the mechanism. The component may comprise at least one of (a) a vehicle trim component, (b) a console, (c) a floor console, (d) a center console, (e) a storage compartment, (f) an arm rest. The cover may comprise at least one of (a) a door, (b) a tambour door, (c) a shade, (d) a blind, (e) a roller blind.

The present invention relates to a component for a vehicle interior comprising: a base comprising a compartment; and a cover configured to move relative to the base in a closing direction from an open position to expose the compartment to a closed position to cover the compartment through an intermediate position. At least one of the cover or the base may comprise a mechanism comprising a spring configured to extend as the cover moves from the intermediate position toward the open position. The mechanism may be configured to bias the cover toward the intermediate position when the cover is in the open position. The cover may comprise a front edge and a rear edge; the rear edge of the cover may be configured to extend the spring. The base may comprise the mechanism and the cover may be configured to initiate contact with the mechanism at the intermediate position as the cover moves from the closed position toward the open position. The mechanism may comprise a tab and the cover may comprise a tab configured to engage the tab of the mechanism.

The present invention relates to a component for a vehicle interior comprising: a base comprising a compartment; and a cover configured for movement relative to the base from an open position to expose the compartment to a closed position to cover the compartment through an intermediate position. At least one of the cover or the base may comprise a mechanism configured to (a) increase a force to move the cover from the intermediate position toward the open position and (b) reduce a force to move the cover from the open position to the intermediate position. The mechanism may comprise a spring mechanism comprising a coil spring. The mechanism may comprise a spring configured to (a) extend as the cover moves from the intermediate position toward the open position; (b) compress as the cover moves from the open position toward the intermediate position. The mechanism may comprise a tab and the cover may comprise a tab configured to engage the tab of the mechanism.

The present invention relates to a vehicle interior component for a vehicle configured to be operated by a force provided by an occupant comprising: a base; a cover configured for movement along a guide between a closed position and an open position to allow access into the base; and a spring mechanism configured to apply a force to the cover. The cover may be configured so that movement of the cover from the open position toward the closed position may comprise (a) a zone of movement assisted by the force from the spring mechanism and assisted by the force by the occupant to lift the cover and (b) a zone of movement unassisted by the force from the spring mechanism and assisted by the force from the occupant to slide the cover toward the closed position. The cover may be configured so that movement of the cover from the closed position toward the open position may comprise (a) a zone of movement unassisted by the force from the spring mechanism and assisted by the force from the occupant to slide the cover toward the open position and (b) a zone of movement restrained by the force from the spring mechanism as the cover moves to the open position.

The present invention relates to a component for a vehicle interior comprising a base comprising a compartment and a cover configured to move relative to the base in a closing direction from an open position to expose the compartment to a closed position to cover the compartment through an intermediate position; at least one of the cover or the base may comprise a mechanism configured to bias the cover toward the intermediate position when the cover is in the open position. The mechanism may comprise a spring configured to extend as the cover moves from the intermediate position toward the open position. The base may comprise a guide; the mechanism may be configured to extend within the guide as the cover moves from the closed position toward the intermediate position. The cover may be configured to separate from the mechanism as the cover moves from the intermediate position toward the closed position. The cover may comprise a front edge and a rear edge; the mechanism may be configured to push the rear edge of the cover in the closing direction. The base may comprise a rear compartment configured to store the cover in the open position; the mechanism may be installed at the rear compartment. The cover may comprise a front portion and a rear portion; the front portion of the cover may comprise a tab; the mechanism may be configured to push the tab at the front portion of the cover in the closing direction. The base may comprise a structure comprising a first sidewall and a second sidewall to define the compartment and the mechanism may be installed with at least one of the first sidewall and the second sidewall. The mechanism may comprise a tab extending from the at least one of the first sidewall and the second sidewall to engage the cover. The cover may comprise a tab extending into at least one of the first sidewall and the second sidewall to engage the mechanism. The mechanism may comprise a tab and the cover may comprise a tab configured to engage the tab of the mechanism. The mechanism may comprise a first mechanism installed at the first sidewall and a second mechanism installed at the second sidewall. The mechanism may be configured to provide a force to oppose movement of the cover from the intermediate position toward the open position. The mechanism may comprise a spring configured to compress as the cover moves from the open position toward the intermediate position. The cover may comprise a front edge and a rear edge; the rear edge of the cover may be configured to extend the spring. The base may comprise the mechanism and the cover may be configured to initiate contact with the mechanism at the intermediate position as the cover moves from the closed position toward the open position. The component may comprise a gap between the cover and the mechanism when the cover is in the closed position. The component may comprise at least one of (a) a vehicle trim component, (b) a console, (c) a floor console, (d) a center console, (e) a storage compartment, (f) an arm rest; and the cover may comprise at least one of (a) a door, (b) a tambour door, (c) a shade, (d) a blind, (e) a roller blind.

The present invention relates to a component for a vehicle interior comprising a base comprising a compartment and a cover configured for movement relative to the base from an open position to expose the compartment to a closed position to cover the compartment through an intermediate position; at least one of the cover or the base may comprise a mechanism configured to provide (a) a braking force to the cover as the cover moves from the intermediate position toward the open position and (b) an assist force to the cover as the cover moves from the open position to the intermediate position.

The present invention relates to a component for a vehicle interior comprising a base comprising a compartment and a cover configured for movement relative to the base from an open position to expose the compartment to a closed position to cover the compartment through an intermediate position; at least one of the cover or the base may comprise a mechanism configured to (a) increase a force to move the cover from the intermediate position toward the open position and (b) reduce a force to move the cover from the open position to the intermediate position.

The present invention relates to a vehicle interior component for a vehicle configured to be operated by a force provided by an occupant comprising a base and a cover configured for movement along a guide between a closed position and an open position to allow access into the base and a spring mechanism configured to apply a force to the cover; the cover may be configured so that movement of the cover from the open position toward the closed position may comprise (a) a zone of movement assisted by the force from the spring mechanism and assisted by the force by the occupant to lift the cover and (b) a zone of movement unassisted by the force from the spring mechanism and assisted by the force from the occupant to slide the cover toward the closed position; the cover may be configured so that movement of the cover from the closed position toward the open position may comprise (a) a zone of movement unassisted by the force from the spring mechanism and assisted by the force from the occupant to slide the cover toward the open position and (b) a zone of movement restrained by the force from the spring mechanism as the cover moves to the open position. The cover may comprise a door. Movement of the door from the open position may comprise unlatching the door from the base; movement of the door toward the closed position may comprise securing the door to the base; movement of the door into the open position may be assisted by a mass gravity force. The open position may comprise a fully retracted position for the door relative to the base. The open position may comprise a stowed position for the door within the base. The base may comprise a recess configured to provide a stowed position for the door; the mechanism may comprise a spring at least partially within the recess and coupled to the base and to the door; and the spring may be configured to provide (a) a force to assist movement of the door toward the closed position as the door is moved from the stowed position and (b) a force to restrain movement of the door toward the open position as the door is moved into the stowed position. The base may comprise the guide. The spring mechanism may comprise at least one spring. The spring mechanism may comprise a coil spring. The coil spring may be coupled at one end to the base and at one end to the door. The door may be configured so that movement of the door may comprise (a) a transition position between the open position to the closed position the spring mechanism may be configured to transition from engagement with the door to provide a force to the door to assist movement to disengagement from the door and (b) a transition position between the closed position and the open position the spring mechanism may be configured to transition from disengagement with the door to engagement with the door to provide a force to the door to restrain movement. The cover may be in a generally vertical orientation when in the open position; the cover may be stowed in a recess in the base when in the open position; the cover may be in a generally horizontal orientation when moving to the closed position; the cover may be in a generally horizontal position when in the closed position. The guide may comprise a track.

The present invention relates to a vehicle interior component for a vehicle configured to be operated by a force provided by an occupant comprising a base and a door assembly comprising (a) a door configured for movement along a guide between a closed position and an open position to allow access into the base and (b) a mechanism configured to apply a force to the door/cover; the door assembly may be configured so that movement of the door from the open position toward the closed position may comprise (a) a zone of movement assisted by the force from the mechanism and assisted by the force by the occupant to lift the door and (b) a zone of movement unassisted by the force from the mechanism and assisted by the force from the occupant to slide the door toward the closed position; the door assembly may be configured so that movement of the door from the closed position toward the open position may comprise (a) a zone of movement unassisted by the force from the mechanism and assisted by the force from the occupant to slide the door toward the open position and (b) a zone of movement restrained by the force from the spring mechanism as the door moves to the open position. The mechanism may comprise a spring mechanism comprising at least one spring. The door may be configured for movement to a transition position between the closed position and the open position; at the transition position the mechanism may be configured to transition to engagement with the door to provide a force to the door to restrain movement. The door may be configured for movement to a transition position between the open position and the closed position; at the transition position the mechanism may be configured to transition to disengagement from the door. The door may be configured for movement to a transition position between the closed position and the open position; at the transition position the mechanism may be configured to transition from disengagement with the door to engagement with the door to provide a force to the door to restrain movement. The door may be configured for movement to a transition position between the open position and the closed position; at the transition position the mechanism may be configured to transition from engagement with the door to provide a force to the door to assist movement to disengagement from the door. The door assembly may be configured to provide (a) a transition position between the zone of movement assisted by the force from the mechanism and the zone of movement unassisted by the force from the mechanism as the door is moved from the open position to the closed position and (b) a transition position between the zone of movement unassisted by the force from the mechanism the zone of movement restrained by the force from the mechanism as the door is moved from the closed position to the open position. The base may comprise the mechanism. The door assembly may be contained in the base; the base may comprise a recess configured to provide a stowed position for the door; the mechanism may comprise a spring at least partially within the recess and coupled to the base and to the door; the spring may be configured to provide (a) a force to assist movement of the door between the open position and the closed position as the door is moved from the stowed position and (b) a force to restrain movement between the closed position and the open position as the door is moved into the stowed position. The base may comprise a console. The door may comprise a cover.

The present invention relates to a component for a vehicle interior comprising a base comprising a compartment and a cover configured to move relative to the base in a closing direction from (a) an open position to expose the compartment to (b) a closed position to cover the compartment through (c) an intermediate position. At least one of the cover or the base may comprise a mechanism configured to bias the cover toward the intermediate position when the cover is in the open position. The mechanism may comprise a spring configured to extend as the cover moves from the intermediate position toward the open position. The base may comprise a guide. The mechanism may be configured to extend within the guide as the cover moves from the closed position toward the intermediate position. The cover may be configured to separate from the mechanism as the cover moves from the intermediate position toward the closed position. The cover may comprise a front edge and a rear edge. The mechanism may be configured to push the rear edge of the cover in the closing direction. The base may comprise a rear compartment configured to store the cover in the open position. The mechanism may be installed at the rear compartment. The cover may comprise a front portion and a rear portion. The front portion of the cover may comprise a tab. The mechanism may be configured to push the tab at the front portion of the cover in the closing direction. The base may comprise a structure comprising a first sidewall and a second sidewall to define the compartment. The mechanism may be installed with at least one of the first sidewall and the second sidewall. The mechanism may comprise a tab extending from at least one of the first sidewall and the second sidewall to engage the cover. The cover may comprise a tab extending into at least one of the first sidewall and the second sidewall to engage the mechanism. The mechanism may comprise a tab and the cover may comprise a tab configured to engage the tab of the mechanism. The mechanism may comprise a first mechanism installed at the first sidewall and a second mechanism installed at the second sidewall. The mechanism may be configured to provide a force to oppose movement of the cover from the intermediate position toward the open position. The mechanism may comprise a spring configured to compress as the cover moves from the open position toward the intermediate position. The cover may comprise a front edge and a rear edge. The rear edge of the cover may be configured to extend the spring. The base may comprise the mechanism The cover may be configured to initiate contact with the mechanism at the intermediate position as the cover moves from the closed position toward the open position. The component may comprise a gap between the cover and the mechanism when the cover is in the closed position. The component may comprise at least one of (a) a vehicle trim component, (b) a console, (c) a floor console, (d) a center console, (e) a storage compartment, (f) an arm rest. The cover may comprise at least one of (a) a door, (b) a tambour door, (c) a shade, (d) a blind, (e) a roller blind.

The present invention also relates to a component for a vehicle interior comprising a base comprising a compartment and a cover configured to move relative to the base in a closing direction from (a) an open position to expose the compartment to (b) a closed position to cover the compartment through (c) an intermediate position. At least one of the cover or the base may comprise a mechanism configured to provide (a) a breaking force to the cover as the cover moves from the intermediate position toward the open position and (b) an assist force to the cover as the cover moves from the open position to the intermediate position. The mechanism may comprise a spring configured to extend as the cover moves from the intermediate position toward the open position. The base may comprise a guide. The mechanism may be configured to extend within the guide as the cover moves from the closed position toward the intermediate position. The cover may be configured to separate from the mechanism as the cover moves from the intermediate position toward the closed position. The cover may comprise a front edge and a rear edge. The mechanism may be configured to push the rear edge of the cover in the closing direction. The base may comprise a rear compartment configured to store the cover in the open position. The mechanism may be installed at the rear compartment. The cover may comprise a front portion and a rear portion. The front portion of the cover may comprise a tab. The mechanism may be configured to push the tab at the front portion of the cover in the closing direction. The base may comprise a structure comprising a first sidewall and a second sidewall to define the compartment. The mechanism may be installed with at least one of the first sidewall and the second sidewall. The mechanism may comprise a tab extending from at least one of the first sidewall and the second sidewall to engage the cover. The cover may comprise a tab extending into at least one of the first sidewall and the second sidewall to engage the mechanism. The mechanism may comprise a tab and the cover may comprise a tab configured to engage the tab of the mechanism. The mechanism may comprise a first mechanism installed at the first sidewall and a second mechanism installed at the second sidewall. The mechanism may be configured to provide a force to oppose movement of the cover from the intermediate position toward the open position. The mechanism may comprise a spring configured to compress as the cover moves from the open position toward the intermediate position. The cover may comprise a front edge and a rear edge. The rear edge of the cover may be configured to extend the spring. The base may comprise the mechanism. The cover may be configured to initiate contact with the mechanism at the intermediate position as the cover moves from the closed position toward the open position. The component may comprise a gap between the cover and the mechanism when the cover is in the closed position. The component may comprise at least one of (a) a vehicle trim component, (b) a console, (c) a floor console, (d) a center console, (e) a storage compartment, (f) an arm rest. The cover may comprise at least one of (a) a door, (b) a tambour door, (c) a shade, (d) a blind, (e) a roller blind.

The present invention relates to a component for a vehicle interior comprising a base comprising a compartment and a cover configured to move relative to the base in a closing direction from (a) an open position to expose the compartment to (b) a closed position to cover the compartment through (c) an intermediate position. At least one of the cover or the base may comprise a mechanism configured to (a) increase a force to move the cover from the intermediate position toward the open position and (b) reduce a force to move the cover from the open position to the intermediate position. The mechanism may comprise a spring configured to extend as the cover moves from the intermediate position toward the open position. The base may comprise a guide. The mechanism may be configured to extend within the guide as the cover moves from the closed position toward the intermediate position. The cover may be configured to separate from the mechanism as the cover moves from the intermediate position toward the closed position. The cover may comprise a front edge and a rear edge. The mechanism may be configured to push the rear edge of the cover in the closing direction. The base may comprise a rear compartment configured to store the cover in the open position. The mechanism may be installed at the rear compartment. The cover may comprise a front portion and a rear portion. The front portion of the cover may comprise a tab. The mechanism may be configured to push the tab at the front portion of the cover in the closing direction. The base may comprise a structure comprising a first sidewall and a second sidewall to define the compartment. The mechanism may be installed with at least one of the first sidewall and the second sidewall. The mechanism may comprise a tab extending from at least one of the first sidewall and the second sidewall to engage the cover. The cover may comprise a tab extending into at least one of the first sidewall and the second sidewall to engage the mechanism. The mechanism may comprise a tab and the cover may comprise a tab configured to engage the tab of the mechanism. The mechanism may comprise a first mechanism installed at the first sidewall and a second mechanism installed at the second sidewall. The mechanism may be configured to provide a force to oppose movement of the cover from the intermediate position toward the open position. The mechanism may comprise a spring configured to compress as the cover moves from the open position toward the intermediate position. The cover may comprise a front edge and a rear edge. The rear edge of the cover may be configured to extend the spring. The base may comprise the mechanism The cover may be configured to initiate contact with the mechanism at the intermediate position as the cover moves from the closed position toward the open position. The component may comprise a gap between the cover and the mechanism when the cover is in the closed position. The component may comprise at least one of (a) a vehicle trim component, (b) a console, (c) a floor console, (d) a center console, (e) a storage compartment, (f) an arm rest. The cover may comprise at least one of (a) a door, (b) a tambour door, (c) a shade, (d) a blind, (e) a roller blind.

### FIGURES

FIG. 1A is a schematic perspective view of a vehicle according to an exemplary embodiment.

FIG. 1B is a schematic perspective view of a vehicle interior according to an exemplary embodiment.

FIG. 1C is a schematic perspective view of a component for a vehicle interior with a cover in a closed position according to an exemplary embodiment.

FIGS. 1D to 1E are schematic perspective views of a component for a vehicle interior with a cover moved between an intermediate position and an open position according to an exemplary embodiment.

FIGS. 1F to 1G are schematic perspective views of a component for a vehicle interior with a cover moved between an intermediate position and a closed position according to an exemplary embodiment.

FIG. 2A is a schematic exploded perspective view of a component for a vehicle interior.

FIG. 2B is a schematic exploded perspective view of a mechanism of a component for a vehicle interior.

FIG. 2C is a partial schematic perspective view of a mechanism of a component for a vehicle interior.

FIGS. 3A to 3C are schematic perspective views of a component for a vehicle interior with a cover moved between a closed position and an open position through an intermediate position according to an exemplary embodiment.

FIGS. 4A to 4C are schematic partial section views of a component for a vehicle interior with a cover moved between a closed position and an open position through an intermediate position according to an exemplary embodiment.

FIGS. 5A to 5C are schematic partial section views of a component for a vehicle interior with a cover moved between a closed position and an open position through an intermediate position according to an exemplary embodiment.

FIG. 6 is a schematic representation of a diagram providing a graph representational of force to open a cover of a vehicle interior component according to an exemplary embodiment.

FIGS. 7A to 7C are schematic perspective views of a component for a vehicle interior with a cover moved between an open position and a closed position through an intermediate position according to an exemplary embodiment.

FIGS. 8A to 8C are partial schematic section views of a component for a vehicle interior with a cover moved between an open position and a closed position through an intermediate position according to an exemplary embodiment.

FIGS. 9A to 9C are partial schematic section views of a component for a vehicle interior with a cover moved between an open position and a closed position through an intermediate position according to an exemplary embodiment.

FIG. 10 is a schematic representation of a diagram providing a graph representational of force to close a cover of a vehicle interior component according to an exemplary embodiment.

FIG. 11 is a schematic exploded perspective view of a component for a vehicle interior.

FIGS. 12A to 12C are schematic perspective views of a component for a vehicle interior with a cover moved between a closed position and an open position through an intermediate position according to an exemplary embodiment.

FIGS. 13A to 13C are schematic partial section views of a component for a vehicle interior with a cover moved between a closed position and an open position through an intermediate position according to an exemplary embodiment.

FIGS. 14A to 14C are schematic partial section views of a component for a vehicle interior with a cover moved between a closed position and an open position through an intermediate position according to an exemplary embodiment.

FIG. 15 is a schematic representation of a diagram providing a graph representational of force to open a cover of a vehicle interior component according to an exemplary embodiment.

FIGS. 16A to 16C are schematic perspective views of a component for a vehicle interior with a cover moved between an open position and a closed position through an intermediate position according to an exemplary embodiment.

FIGS. 17A to 17C are schematic partial section views of a component for a vehicle interior with a cover moved between an open position and a closed position through an intermediate position according to an exemplary embodiment.

FIGS. 18A to 18C are schematic partial section views of a component for a vehicle interior with a cover moved between an open position and a closed position through an intermediate position according to an exemplary embodiment.

FIG. 19 is a schematic representation of a diagram providing a graph representational of force to close a cover of a vehicle interior component according to an exemplary embodiment.

FIGS. 20A to 20C are schematic and representational diagrams of force to move the cover/door assembly between the open position and closed position according to an exemplary embodiment.

### DESCRIPTION

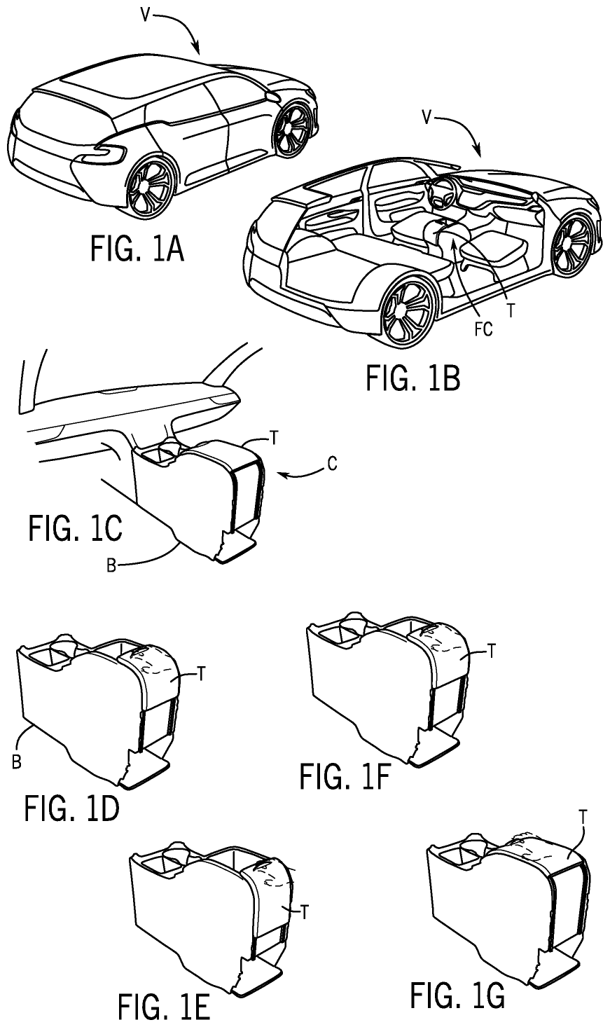

According to an exemplary embodiment as shown schematically in FIGS. 1A to 1B, a vehicle V is shown including an interior with a vehicle interior component or floor console FC. Floor console FC may comprise a base B and a cover shown as a tambour door T.

According to an exemplary embodiment as shown schematically in FIGS. 1C to 1E, a component C (e.g. vehicle trim component, console, center console, floor console, storage compartment, arm rest, etc.) for a vehicle interior may comprise a base B and a cover shown as a tambour door T. Cover T may be configured to conform to a curved structure of base B as cover T moves between a closed position and an open position to facilitate access to a storage compartment. According to an exemplary embodiment, a hand H may exert an external force to move cover T from a closed position as shown schematically in FIG. 1C to an open position as shown schematically in FIG. 1E through an intermediate position as shown schematically in FIG. 1D. According to an exemplary embodiment, a hand H may exert an external force to move cover T from an open position as shown schematically in FIG. 1E to a closed position as shown schematically in FIG. 1G through an intermediate position as shown schematically in FIG. 1F.

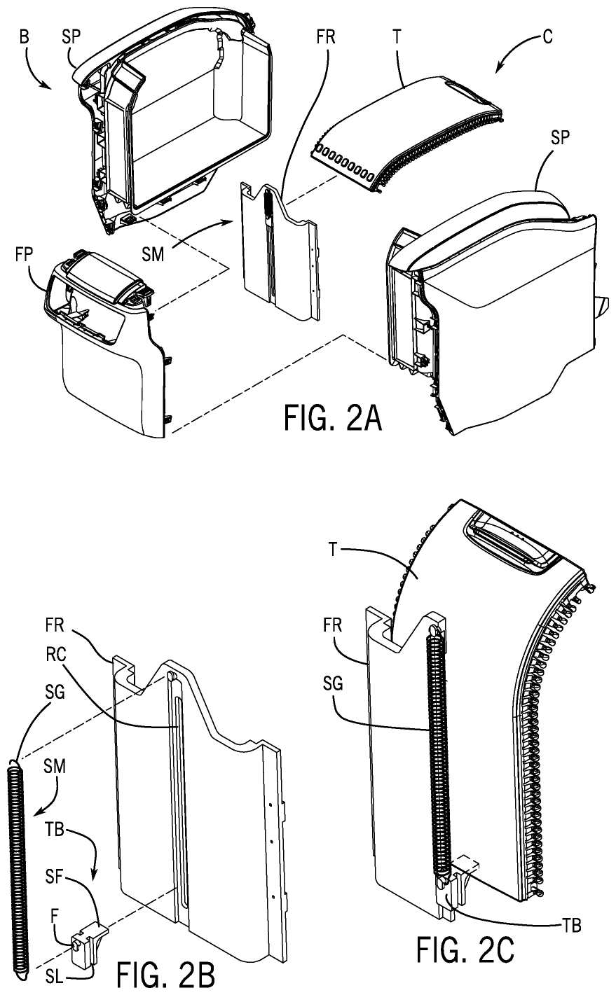

According to an exemplary embodiment as shown schematically in FIG. 2A, a component C (e.g. vehicle trim component, console, center console, floor console, storage compartment, arm rest, etc.) for a vehicle interior may comprise a base B, a cover T (e.g. a door, a tambour door, a shade, a blind, a roller blind) and a mechanism SM. Cover T may be configured to move relative to base B in a closing direction from (a) an open position to expose the compartment to (b) a closed position to cover the compartment through (c) an intermediate position. At least one of cover T or base B may comprise mechanism SM. Mechanism SM may be configured to bias cover T toward the intermediate position when cover T is in the open position. Mechanism SM may be configured to provide (a) a breaking force to cover T as cover T moves from the intermediate position toward the open position and (b) an assist force to cover T as cover T moves from the open position to the intermediate position. Mechanism SM may be configured to (a) increase a force to move cover T from the intermediate position toward the open position and (b) reduce a force to move cover T from the open position to the intermediate position. Mechanism SM may be configured to provide a force to move cover T from the closed position toward the intermediate position. Cover T may be configured to separate from mechanism SM as cover T moves from the intermediate position toward the closed position. Cover T may comprise a front edge and a rear edge. Mechanism SM may be configured to push the rear edge of cover T in the closing direction. Base B may comprise a rear compartment configured to store cover T in the open position. Mechanism SM may be installed at the rear compartment. Mechanism SM may be configured to provide a force to oppose movement of cover T from the intermediate position toward the open position. Mechanism SM may comprise a spring configured to extend as cover T moves from the intermediate position toward the open position. Cover T may comprise a front edge and a rear edge. The rear edge of cover T may be configured to extend the spring. Base B may comprise mechanism SM. Cover T may be configured to initiate contact with mechanism SM at the intermediate position as cover T moves from the closed position toward the open position. Component C may comprise a gap between cover T and mechanism SM when cover T is in the closed position. Component C may comprise at least one of (a) a vehicle trim component, (b) a console, (c) a floor console, (d) a center console, (e) a storage compartment, (f) an arm rest. The cover may comprise at least one of (a) a door, (b) a tambour door, (c) a shade, (d) a blind, (e) a roller blind.

According to an exemplary embodiment as shown schematically in FIG. 2B, mechanism SM may comprise a spring SG and a tab TB. Tab TB may comprise an attachment feature F, a slot SL and a surface SF. Spring SG may attach to tab TB at attachment feature F. Spring SG may be configured to extend as cover T moves from the intermediate position toward the open position. Base B may comprise a guide RC and an attachment feature. Mechanism SM may be configured to extend within guide RC as cover T moves from the closed position toward the intermediate position. Spring SG may attach to base B at the attachment feature.

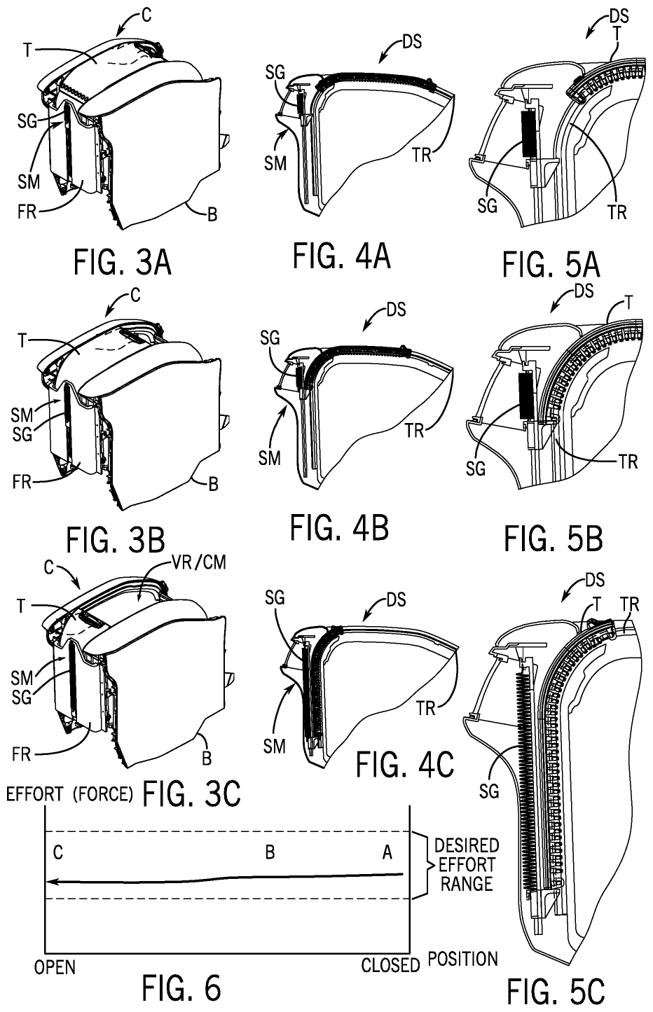

According to an exemplary embodiment, cover T of component C may be configured to move relative to base B in an opening direction from a closed position as shown schematically in FIG. 3A to an open position to uncover a volume/receptacle/compartment VR/CM as shown schematically in FIG. 3C through an intermediate position as shown schematically in FIG. 3B. According to an exemplary embodiment as shown schematically in FIGS. 3A to 3C, mechanism SM may be configured to provide a breaking force to cover T as cover T moves from the intermediate position toward the open position. Mechanism SM may be configured to increase a force to move cover T from the intermediate position toward the open position. Base B may comprise a rear compartment configured to store cover T in the open position as shown schematically in FIG. 3C. Mechanism SM may be installed at the rear compartment. Mechanism SM may be configured to provide a force to oppose movement of cover T from the intermediate position toward the open position. Spring SG may be configured to extend as cover T moves from the intermediate position toward the open position. Cover T may comprise rear edge. The rear edge of cover T may be configured to extend spring SG as shown schematically in FIGS. 3B and 3C.

According to an exemplary embodiment, cover T of component C may be configured to move relative to base B in an opening direction from a closed position as shown schematically in FIG. 4A to an open position to uncover a volume/receptacle/compartment VR/CM as shown schematically in FIG. 4C through an intermediate position as shown schematically in FIG. 4B. According to an exemplary embodiment as shown schematically in FIGS. 4A to 4C, cover T may comprise a front edge and a rear edge. The rear edge of cover T may be configured to extend spring SG as shown schematically in FIG. 4C. Cover T may be configured to initiate contact with mechanism SM at the intermediate position as cover T moves from the closed position toward the open position as shown schematically in FIG. 4B. Component C may comprise a gap between cover T and mechanism SM when cover T is in the closed position as shown schematically in FIG. 4A.

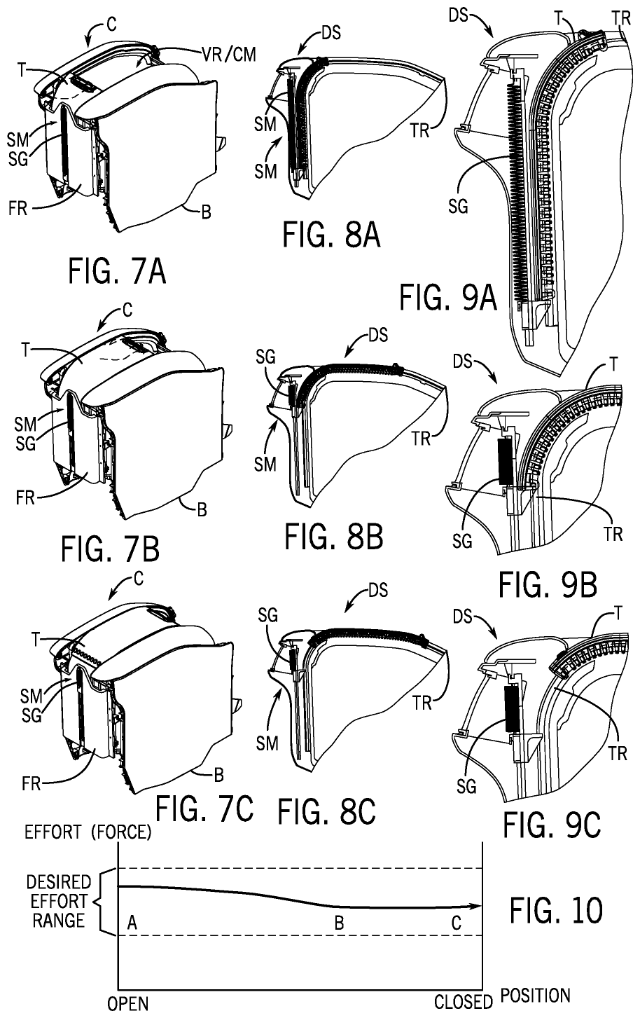

According to an exemplary embodiment, cover T of component C may be configured to move relative to base B in a closing direction from an open position to expose volume/receptacle/compartment VR/CM as shown schematically in FIG. 7A to a closed position to cover volume/receptacle/compartment VR/CM as shown schematically in FIG. 7C through an intermediate position as shown schematically in FIG. 7B. According to an exemplary embodiment as shown schematically in FIGS. 7A to 7C, mechanism SM may be configured to bias cover T toward the intermediate position when cover T is in the open position. Mechanism SM may be configured to provide an assist force to cover T as cover T moves from the open position to the intermediate position. Mechanism SM may be configured to reduce a force to move cover T from the open position to the intermediate position. Mechanism SM may be configured to provide a force to move cover T from the closed position toward the intermediate position.

According to an exemplary embodiment, cover T of component C may be configured to move relative to base B in a closing direction from an open position to expose volume/receptacle/compartment VR/CM as shown schematically in FIG. 8A to a closed position to cover volume/receptacle/compartment VR/CM as shown schematically in FIG. 8C through an intermediate position as shown schematically in FIG. 8B. According to an exemplary embodiment as shown schematically in FIGS. 8A to 8C, cover T may be configured to separate from mechanism SM as cover T moves from the intermediate position toward the closed position as shown schematically in FIGS. 8B and 8C. Cover T may comprise a front edge and a rear edge. Mechanism SM may be configured to provide a force to move the cover from the open position toward the intermediate position as shown schematically in FIGS. 8A, 8B, 9A and 9B. Mechanism SM may be configured to push the rear edge of cover T in the closing direction as shown schematically in FIGS. 8A, 8B, 9A and 9B. Component C may comprise a gap G between cover T and mechanism SM when cover T is in the closed position as shown schematically in FIG. 8C. Spring SG may be configured to compress as cover T moves from the open position toward the intermediate position.

According to an exemplary embodiment as shown schematically in FIG. 11, a component C (e.g. vehicle trim component, console, center console, floor console, storage compartment, arm rest, etc.) for a vehicle interior may comprise a base B, a cover T (e.g. a door, a tambour door, a shade, a blind, a roller blind) and a mechanism SM. Cover T may be configured to move relative to base B in a closing direction from (a) an open position to expose the compartment to (b) a closed position to cover the compartment through (c) an intermediate position. At least one of cover T or base B may comprise mechanism SM. Mechanism SM may be configured to bias cover T toward the intermediate position when cover T is in the open position. Mechanism SM may be configured to provide (a) a breaking force to cover T as cover T moves from the intermediate position toward the open position and (b) an assist force to cover T as cover T moves from the open position to the intermediate position. Mechanism SM may be configured to (a) increase a force to move cover T from the intermediate position toward the open position and (b) reduce a force to move cover T from the open position to the intermediate position. Mechanism SM may be configured to provide a force to move cover T from the closed position toward the intermediate position. Cover T may be configured to separate from mechanism SM as cover T moves from the intermediate position toward the closed position. Base B may comprise a rear compartment configured to store cover T in the open position. Mechanism SM may be configured to provide a force to oppose movement of cover T from the intermediate position toward the open position. Mechanism SM may comprise a spring or set of springs SG configured to extend as cover T moves from the intermediate position toward the open position. Base B may comprise mechanism SM. Cover T may be configured to initiate contact with mechanism SM at the intermediate position as cover T moves from the closed position toward the open position. Component C may comprise a gap between cover T and mechanism SM when cover T is in the closed position. Cover T may comprise a front portion and a rear portion. The front portion of cover T may comprise a tab or set of tabs. Mechanism SM may be configured to push the tab or set of tabs at the front portion of cover T in the closing direction. Base B may comprise a structure comprising a first sidewall and a second sidewall to define the compartment. Mechanism SM may be installed with at least one of the first sidewall and the second sidewall. Mechanism SM may comprise a tab or set of tabs TB extending from at least one of the first sidewall and the second sidewall to engage cover T. Cover T may comprise a tab or set of tabs extending into at least one of the first sidewall and the second sidewall to engage mechanism SM. Mechanism SM may comprise a tab or set of tabs TB and cover T may comprise a tab or set of tabs configured to engage tab or set of tabs TB of mechanism SM. Mechanism SM may comprise a first mechanism installed at the first sidewall and a second mechanism installed at the second sidewall. Component C may comprise at least one of (a) a vehicle trim component, (b) a console, (c) a floor console, (d) a center console, (e) a storage compartment, (f) an arm rest. The cover may comprise at least one of (a) a door, (b) a tambour door, (c) a shade, (d) a blind, (e) a roller blind. Tab or set of tabs TB may comprise an attachment feature, a slot and a surface. Spring or set of springs SG may attach to tab or set of tabs TB at the attachment feature. Spring or set of springs SG may be configured to extend as cover T moves from the intermediate position toward the open position. Base B may comprise a guide or set of guides G and an attachment feature or set of attachment features F. Mechanism SM may be configured to extend within guide or set of guides G as cover T moves from the closed position toward the intermediate position. Spring or set of springs SG may attach to base B at attachment feature or set of attachment features F.

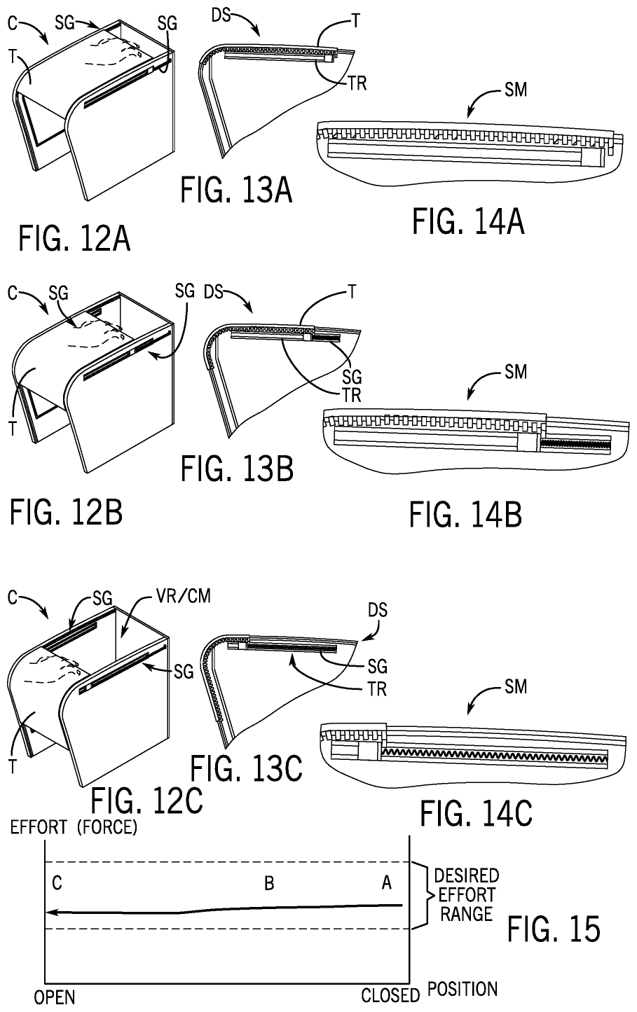

According to an exemplary embodiment, cover T of component C may be configured to move relative to base B in an opening direction from a closed position to cover a volume/receptacle/compartment VR/CM as shown schematically in FIG. 12A to an open position to expose volume/receptacle/compartment VR/CM as shown schematically in FIG. 12C through an intermediate position as shown schematically in FIG. 12B. According to an exemplary embodiment as shown schematically in FIGS. 12A to 12C, mechanism SM may be configured to provide a breaking force to cover T as cover T moves from the intermediate position toward the open position. Mechanism SM may be configured to increase a force to move cover T from the intermediate position toward the open position. Base B may comprise a rear compartment configured to store cover T in the open position. Mechanism SM may be configured to provide a force to oppose movement of cover T from the intermediate position toward the open position. Mechanism SM may comprise a spring or set of springs SG configured to extend as cover T moves from the intermediate position toward the open position. Base B may comprise a structure comprising a first sidewall and a second sidewall to define the compartment. Mechanism SM may be installed with at least one of the first sidewall and the second sidewall. Mechanism SM may comprise a tab or set of tabs TB extending from at least one of the first sidewall and the second sidewall to engage cover T. Mechanism SM may comprise a first mechanism installed at the first sidewall and a second mechanism installed at the second sidewall.

According to an exemplary embodiment, cover T of component C may be configured to move relative to base B in an opening direction from a closed position to cover a volume/receptacle/compartment VR/CM as shown schematically in FIG. 13A to an open position to expose volume/receptacle/compartment VR/CM as shown schematically in FIG. 13C through an intermediate position as shown schematically in FIG. 13B. According to an exemplary embodiment as shown schematically in FIGS. 13A to 13C, mechanism SM may comprise a spring or set of springs SG configured to extend as cover T moves from the intermediate position toward the open position. Cover T may be configured to initiate contact with mechanism SM at the intermediate position as cover T moves from the closed position toward the open position as shown schematically in FIG. 13B. A tab or set of tabs of cover T may be configured to engage a tab or set of tabs TB as shown schematically in FIG. 13B.

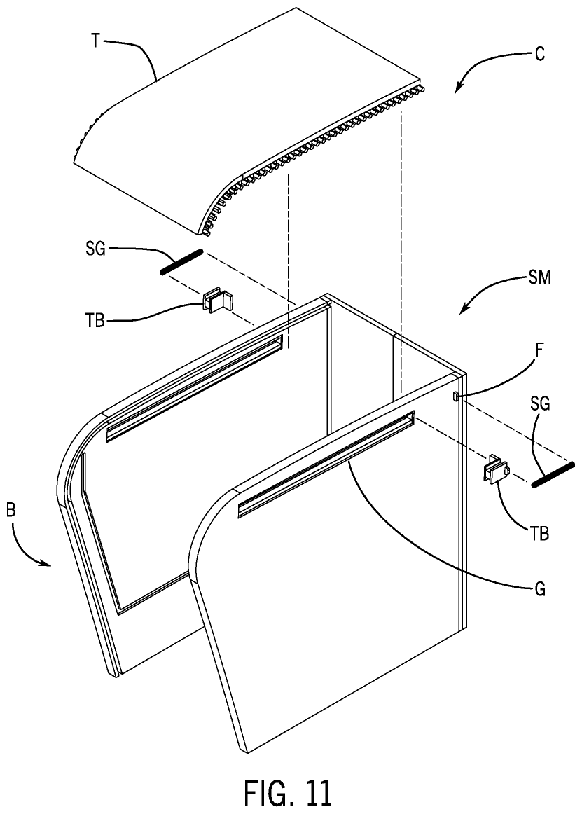

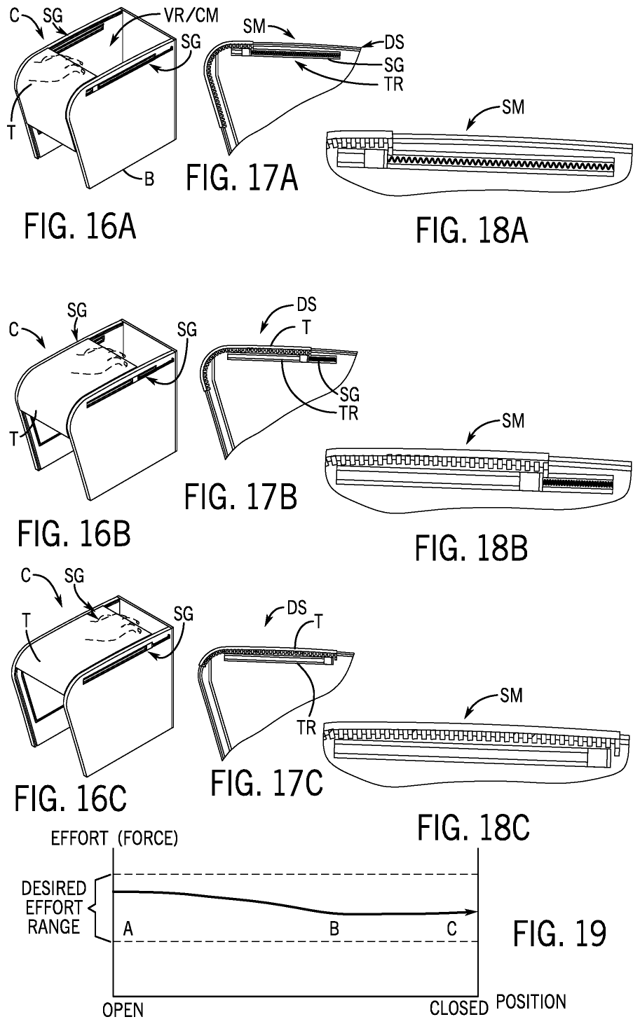

According to an exemplary embodiment, cover T of component C may be configured to move relative to base B in a closing direction from an open position to expose volume/receptacle/compartment VR/CM as shown schematically in FIG. 16A to a closed position to cover volume/receptacle/compartment VR/CM as shown schematically in FIG. 10C through an intermediate position as shown schematically in FIG. 16B. According to an exemplary embodiment as shown schematically in FIGS. 16A to 16C, mechanism SM may be configured to bias cover T toward the intermediate position when cover T is in the open position. Mechanism SM may be configured to provide an assist force to cover T as cover T moves from the open position to the intermediate position. Mechanism SM may be configured to reduce a force to move cover T from the open position to the intermediate position. Mechanism SM may be configured to provide a force to move cover T from the open position toward the intermediate position. Cover T may be configured to separate from mechanism SM as cover T moves from the intermediate position toward the closed position.

According to an exemplary embodiment, cover T of component C may be configured to move relative to base B in a closing direction from an open position to expose volume/receptacle/compartment VR/CM as shown schematically in FIG. 17A to a closed position to cover volume/receptacle/compartment VR/CM as shown schematically in FIG. 11C through an intermediate position as shown schematically in FIG. 17B. According to an exemplary embodiment as shown schematically in FIGS. 17A to 17C, cover T may be configured to separate from mechanism SM as cover T moves from the intermediate position toward the closed position. Mechanism SM may be configured to push a tab or set of tabs at the front portion of cover T in the closing direction. Tab or set of tabs TB may be configured to engage the tab or set of tabs at the front portion of cover T. Spring or set of springs SG may be configured to compress as cover T moves from the open position toward the intermediate position.

### Exemplary Embodiments

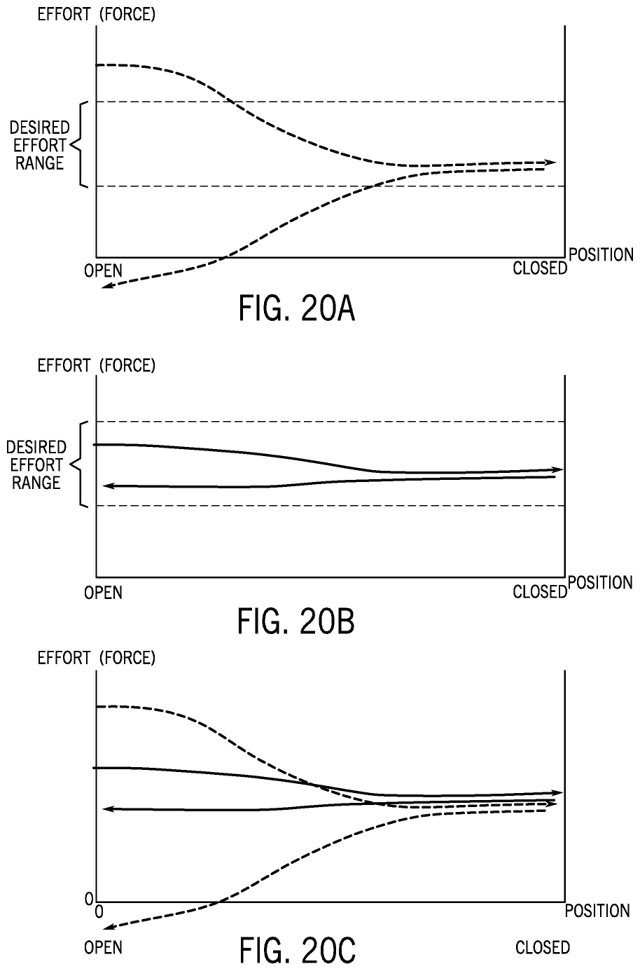

According to an exemplary embodiment shown schematically in FIGS. 1C-1G, 2A-2C and 11, a component C for a vehicle interior may comprise a base B comprising a compartment CM and a cover T configured to move relative to the base in a closing direction from an open position to expose the compartment to a closed position to cover the compartment through an intermediate position; at least one of the cover or the base may comprise a mechanism SM configured to bias the cover toward the intermediate position when the cover may be in the open position. See also FIGS. 3A-3C, 7A-7C and 12A-12C, 16A-16C (e.g. component/assembly comprising door/cover operable by effort/force applied by vehicle occupant and with mechanism to move between open/closed positions through intermediate/transition positions) and FIGS. 20B-20C.

According to an exemplary embodiment shown schematically, the mechanism SM may comprise a spring configured to extend as the cover moves from the intermediate position toward the open position. See e.g. FIGS. 2A-2C, 3A-3C, 4A-4C, 5A-5C, 11, 12A-12C, 13A-13C and 14A-14C (cover/door of component/assembly shown schematically with mechanism to provide force to resist/restrain movement of cover/door).

According to an exemplary embodiment shown schematically, the base B may comprise a guide TR; the mechanism may be configured to extend within the guide as the cover moves from the closed position toward the intermediate position. See e.g. FIGS. 2A-2C and 11 (construction of base/assembly with guide/track arrangement and cover/door/assembly and mechanism shown as spring mechanism) and FIGS. 4A-4C and 13A-13C.

According to an exemplary embodiment shown schematically, the cover may be configured to separate from the mechanism as the cover moves from the intermediate position toward the closed position; the cover may comprise a front edge and a rear edge; the mechanism may be configured to push the rear edge of the cover in the closing direction. See e.g. FIGS. 7A-7C, 8A-8C, 9A-9C and 16A-16C, 17A-17C, 18A-18C (cover/door of component/assembly shown schematically in movement from open position through intermediate position to closed position); see also FIGS. 10 and 19.

According to an exemplary embodiment shown schematically, the base may comprise a rear compartment configured to store the cover in the open position; the mechanism may be installed at the rear compartment (see FIGS. 2A-2C) the base may comprise a structure comprising a first sidewall and a second sidewall to define the compartment and the mechanism may be installed with at least one of the first sidewall and the second sidewall (see FIG. 11).

According to an exemplary embodiment shown schematically, the cover may comprise a front portion and a rear portion; the front portion of the cover may comprise a tab; the mechanism may be configured to push the tab at the front portion of the cover in the closing direction. See e.g. FIGS. 2A-2C and 11 (construction of base/assembly with guide/track arrangement and cover/door/assembly and mechanism shown as spring mechanism).

According to an exemplary embodiment shown schematically, the mechanism may comprise a tab extending from the at least one of the first sidewall and the second sidewall to engage the cover; the cover may comprise a tab extending into at least one of the first sidewall and the second sidewall to engage the mechanism; the mechanism may comprise a tab and the cover may comprise a tab configured to engage the tab of the mechanism. See e.g. FIGS. 2A-2C and 11 (construction of base/assembly with guide/track arrangement and cover/door/assembly and mechanism shown as spring mechanism).

According to an exemplary embodiment shown schematically, the mechanism may comprise a first mechanism installed at the first sidewall and a second mechanism installed at the second sidewall. See e.g. FIGS. 11, 12A-12C, 13A-13C and 14A-14C (construction of base/assembly with guide/track arrangement and cover/door/assembly and operation of mechanism shown as spring mechanism).

According to an exemplary embodiment shown schematically, the mechanism may be configured to provide a force to oppose movement of the cover from the intermediate position toward the open position (see FIGS. 2A-2C and 11); the mechanism may comprise a spring configured to compress as the cover moves from the open position toward the intermediate position. See also FIGS. 3A-3C, 7A-7C and 12A-12C, 16A-16C (e.g. component/assembly comprising door/cover operable by effort/force applied by vehicle occupant and with mechanism to move between open/closed positions through intermediate/transition positions). (The component may comprise a gap between the cover and the mechanism when the cover is in the closed position. See FIG. 9C.)

According to an exemplary embodiment shown schematically, the cover may comprise a front edge and a rear edge; the rear edge of the cover may be configured to extend the spring. See e.g. FIGS. 2A-2C and 11 (construction of base/assembly with guide/track arrangement and cover/door/assembly and mechanism shown as spring mechanism); see also FIGS. 5A-5C, 9A-9C and 14A-14C, 18A-18C.

According to an exemplary embodiment shown schematically, the base may comprise the mechanism and the cover may be configured to initiate contact with the mechanism at the intermediate position as the cover moves from the closed position toward the open position. See e.g. FIGS. 3A-3C, 4A-4C, 5A-5C and 12A-12C, 13A-13C, 14A-14C (cover/door of component/assembly shown schematically in movement from closed position to open position); see also FIGS. 6 and 15.

According to an exemplary embodiment indicated schematically, the component may comprise at least one of (a) a vehicle trim component, (b) a console, (c) a floor console, (d) a center console, (e) a storage compartment, (f) an arm rest; and the cover may comprise at least one of (a) a door, (b) a tambour door, (c) a shade, (d) a blind, (e) a roller blind. See e.g. FIGS. 1A-1C.

According to an exemplary embodiment shown schematically in FIGS. 1C-1G, 2A-2C and 11, a component C for a vehicle interior may comprise a base B comprising a compartment and a cover T configured for movement relative to the base from an open position to expose the compartment to a closed position to cover the compartment through an intermediate position; at least one of the cover or the base may comprise a mechanism SM configured to provide (a) a braking force to the cover as the cover moves from the intermediate position toward the open position and (b) an assist force to the cover as the cover moves from the open position to the intermediate position. See also FIGS. 3A-3C, 7A-7C and 12A-12C, 16A-16C (e.g. component/assembly comprising door/cover operable by effort/force applied by vehicle occupant and with mechanism to move between open/closed positions through intermediate/transition positions) and FIGS. 19 and 20.

According to an exemplary embodiment shown schematically in FIGS. 1C-1G, 2A-2C and 11, a component C for a vehicle interior may comprise a base B comprising a compartment and a cover T configured for movement relative to the base from an open position to expose the compartment to a closed position to cover the compartment through an intermediate position; at least one of the cover or the base may comprise a mechanism SM configured to (a) increase a force to move the cover from the intermediate position toward the open position and (b) reduce a force to move the cover from the open position to the intermediate position. See also FIGS. 3A-3C, 7A-7C and 12A-12C, 16A-16C (e.g. component/assembly comprising door/cover operable by effort/force applied by vehicle occupant and with mechanism to move between open/closed positions through intermediate/transition positions) and FIGS. 20B-20C.

According to an exemplary embodiment shown schematically in FIGS. 1C-1G, 2A-2C and 11, a vehicle interior component C for a vehicle configured to be operated by a force provided by an occupant comprising a base B and a cover T configured for movement along a guide TR between a closed position and an open position to allow access into the base and a spring mechanism SM configured to apply a force to the cover; the cover may be configured so that movement of the cover from the open position toward the closed position may comprise (a) a zone of movement assisted by the force from the spring mechanism and assisted by the force by the occupant to lift the cover and (b) a zone of movement unassisted by the force from the spring mechanism and assisted by the force from the occupant to slide the cover toward the closed position; the cover may be configured so that movement of the cover from the closed position toward the open position may comprise (a) a zone of movement unassisted by the force from the spring mechanism and assisted by the force from the occupant to slide the cover toward the open position and (b) a zone of movement restrained by the force from the spring mechanism as the cover moves to the open position. See also FIGS. 3A-3C, 7A-7C and 12A-12C, 16A-16C (e.g. component/assembly comprising door/cover operable by effort/force applied by vehicle occupant and with mechanism to move between open/closed positions through intermediate/transition positions) and FIGS. 6, 10, 15, 19 and 20B-20C.

According to an exemplary embodiment shown schematically, the cover may comprise a door T. See e.g. FIGS. 2A-2C and 11 (construction of base/assembly with guide/track arrangement and cover/door/assembly and mechanism shown as spring mechanism). Movement of the door from the open position may comprise unlatching the door from the base; movement of the door toward the closed position may comprise securing the door to the base; movement of the door into the open position may be assisted by a mass gravity force. See e.g. FIGS. 2A-2C, 7A-7C, 8A-8C, 9A-9C, 11, 16A-16C, 17A-17C and 18A-18C (cover/door of component/assembly shown schematically with mechanism to provide force to assist movement of cover/door) and FIGS. 20B-20C.

According to an exemplary embodiment shown schematically, the open position may comprise a fully retracted position for the door relative to the base; the open position may comprise a stowed position for the door within the base. See e.g. FIGS. 2A-2C and 4C.

According to an exemplary embodiment shown schematically, the base B may comprise a recess configured to provide a stowed position for the door T; the mechanism SM may comprise a spring SG at least partially within the recess and coupled to the base and to the door; and the spring may be configured to provide (a) a force to assist movement of the door toward the closed position as the door may be moved from the stowed position and (b) a force to restrain movement of the door toward the open position as the door may be moved into the stowed position. See e.g. FIGS. 2A-2C, 7A-7C, 8A-8C, 9A-9C, 11, 16A-16C, 17A-17C and 18A-18C (cover/door of component/assembly shown schematically with mechanism to provide force to assist movement of cover/door).

According to an exemplary embodiment shown schematically, the base B may comprise the guide TR. See e.g. FIGS. 2A-2C and 11 (construction of base/assembly with guide/track arrangement and cover/door/assembly and mechanism shown as spring mechanism).

According to an exemplary embodiment shown schematically, the spring mechanism SM may comprise at least one spring SG (see FIGS. 2A-2C and 11); the spring mechanism SM may comprise a coil spring; the coil spring may be coupled at one end to the base and at one end to the door. See e.g. FIGS. 2A-2C, 7A-7C, 8A-8C, 9A-9C, 11, 16A-16C, 17A-17C and 18A-18C (cover/door of component/assembly shown schematically with mechanism to provide force to assist movement of cover/door).

According to an exemplary embodiment shown schematically, the door may be configured so that movement of the door may comprise (a) a transition position between the open position to the closed position the spring mechanism may be configured to transition from engagement with the door to provide a force to the door to assist movement to disengagement from the door and (b) a transition position between the closed position and the open position the spring mechanism may be configured to transition from disengagement with the door to engagement with the door to provide a force to the door to restrain movement. See e.g. FIGS. 2A-2C, 3A-3C, 4A-4C, 5A-5C, 11, 12A-12C, 13A-13C and 14A-14C (cover/door of component/assembly shown schematically with mechanism to provide force to resist/restrain movement of cover/door); see also FIGS. 20B-20C.

According to an exemplary embodiment shown schematically, the cover may be in a generally vertical orientation when in the open position; the cover may be stowed in a recess in the base when in the open position; the cover may be in a generally horizontal orientation when moving to the closed position; the cover may be in a generally horizontal position when in the closed position. See e.g. FIGS. 1C-1E.

According to an exemplary embodiment shown schematically, the guide may comprise a track. See e.g. FIGS. 2A-2C and 11 (construction of base/assembly with guide/track arrangement).

According to an exemplary embodiment shown schematically in FIGS. 1C-1G, 2A-2C and 11, a vehicle interior component C for a vehicle configured to be operated by a force provided by an occupant may comprise a base B and a door assembly DS comprising a door T configured for movement along a guide TR between a closed position and an open position to allow access into the base and a mechanism SM configured to apply a force to the door/cover; the door assembly may be configured so that movement of the door from the open position toward the closed position may comprise (a) a zone of movement assisted by the force from the mechanism and assisted by the force by the occupant to lift the door and (b) a zone of movement unassisted by the force from the mechanism and assisted by the force from the occupant to slide the door toward the closed position; the door assembly may be configured so that movement of the door from the closed position toward the open position may comprise (a) a zone of movement unassisted by the force from the mechanism and assisted by the force from the occupant to slide the door toward the open position and (b) a zone of movement restrained by the force from the spring mechanism as the door moves to the open position. See also FIGS. 3A-3C, 7A-7C and 12A-12C, 16A-16C (e.g. component/assembly comprising door/cover operable by effort/force applied by vehicle occupant and with mechanism to move between open/closed positions through intermediate/transition positions) and FIGS. 20B-20C.

According to an exemplary embodiment shown schematically, the mechanism may comprise a spring mechanism SM comprising at least one spring SG. See e.g. FIGS. 2A-2C and 11 (construction of base/assembly with guide/track arrangement and cover/door/assembly and mechanism shown as spring mechanism).

According to an exemplary embodiment shown schematically, the door may be configured for movement to a transition position between the closed position and the open position; at the transition position the mechanism may be configured to transition to engagement with the door to provide a force to the door to restrain movement. See e.g. FIGS. 3A-3C, 4A-4C, 5A-5C and 12A-12C, 13A-13C, 14A-14C (cover/door of component/assembly shown schematically in movement from closed position to open position); see also FIGS. 6, 15 and 20B-20C.

According to an exemplary embodiment shown schematically, the door may be configured for movement to a transition position between the open position and the closed position; at the transition position the mechanism may be configured to transition to disengagement from the door. See e.g. FIGS. 7A-7C, 8A-8C, 9A-9C and 16A-16C, 17A-17C, 18A-18C (cover/door of component/assembly shown schematically in movement from open position to closed position); see also FIGS. 10, 19 and 20B-20C.

According to an exemplary embodiment shown schematically, the door may be configured for movement to a transition position between the closed position and the open position; at the transition position the mechanism may be configured to transition from disengagement with the door to engagement with the door to provide a force to the door to restrain movement. See e.g. FIGS. 2A-2C, 3A-3C, 4A-4C, 5A-5C, 11, 12A-12C, 13A-13C and 14A-14C (cover/door of component/assembly shown schematically with mechanism to provide force to resist/restrain movement of cover/door); see also FIGS. 6, 15 and 20A-20B.

According to an exemplary embodiment shown schematically, the door may be configured for movement to a transition position between the open position and the closed position; at the transition position the mechanism may be configured to transition from engagement with the door to provide a force to the door to assist movement to disengagement from the door. See e.g. FIGS. 2A-2C, 7A-7C, 8A-8C, 9A-9C, 11, 16A-16C, 17A-17C and 18A-18C (cover/door of component/assembly shown schematically with mechanism to provide force to assist movement of cover/door); see also FIGS. 10, 19 and 20A-20B.

According to an exemplary embodiment shown schematically, the door assembly DS may be configured to provide (a) a transition position between the zone of movement assisted by the force from the mechanism and the zone of movement unassisted by the force from the mechanism as the door may be moved from the open position to the closed position and (b) a transition position between the zone of movement unassisted by the force from the mechanism the zone of movement restrained by the force from the mechanism as the door may be moved from the closed position to the open position. See FIGS. 20A-20B.

According to an exemplary embodiment shown schematically, the base B may comprise the mechanism SM. See e.g. FIGS. 2A-2C and 11 (construction of base/assembly with guide/track arrangement and cover/door/assembly and mechanism shown as spring mechanism).

According to an exemplary embodiment shown schematically, the door assembly may be contained in the base; the base may comprise a recess configured to provide a stowed position for the door; the mechanism may comprise a spring at least partially within the recess and coupled to the base and to the door; the spring may be configured to provide (a) a force to assist movement of the door between the open position and the closed position as the door may be moved from the stowed position and (b) a force to restrain movement between the closed position and the open position as the door may be moved into the stowed position. See FIGS. 1C-1G, 2A-2C, 3A-3C, 7A-7C, 11, 12A-12C, 16A-16C (e.g. component/assembly comprising door/cover operable by effort/force applied by vehicle occupant and with mechanism to move between open/closed positions through intermediate/transition positions); see also FIGS. 6, 10, 15, 19 and 20A-20B.

According to an exemplary embodiment shown schematically, the base may comprise a console; the door may comprise a cover. See e.g. FIGS. 1B-1G, 2A-2C, 3A-3C, 7A-7C, 11, 12A-12C, 16A-16C.

### Operation of Component/Mechanism

According to an exemplary embodiment shown schematically in FIGS. 1C-1G, 2A-2C and 11, a vehicle interior component C comprises a cover/door T movable along a guide TR between a closed position and an open position relative to a base B; the cover/door is configured to be operated by a force/effort provided by an occupant (e.g. to allow or restrict/block access into a compartment in the base). See e.g. FIGS. 1C-1E, 3A-3C, 6, 7A-7C, 10, 12A-12C, 15, 16A-16, 19 and 20A-20C.

According to an exemplary embodiment as indicated schematically and representationally, the forces encountered in movement of the cover/door relative to the base in addition to by any force/effort provided by the occupant may be determined (e.g. assisted, increased, supplemented, reduced, restrained/restricted, braked, etc.) based on factors related to the design/configuration of the component/assembly, including the mass/gravity effect of the door/assembly, the form/contour of the track/guide, the configuration of the door/assembly as engaged with the track/guide (e.g. internal friction/binding, braking, etc.), changes in the form/shape of the door in travel along the track/guide (e.g. bending, flexing, lengthening, straightening, etc.), direction of movement, orientation of installation, environmental and use/wear effects, material selection/durability, etc. See e.g. FIGS. 20A-20C.

As indicated schematically and representationally according to an exemplary embodiment in FIGS. 6, 10, 15, 19 and 20A-20B, the component/assembly will have a level of force required for movement of the door between the open/closed positions (e.g. force/effort to be supplied by the occupant in use in the operating conditions); for the component/assembly there may be a desired range of effort for force to be applied by the occupant (e.g. force/effort that in a range that is determined to be suitable for operation by a range of expected occupants). See FIGS. 20A-20B (indicating schematically/representationally the desired force level for operation for a door configuration). As indicated schematically and representationally for a door configuration comprising a generally horizontal closed position and a generally vertical open/stowed position, movement from the fully open position to the fully closed position may require force to lift the door vertically to overcome mass/gravity (see e.g. FIGS. 1E-1G and 20A) and then continued movement to the fully closed position may require relatively less force/effort to slide the door horizontally to overcome the force/effect of friction, etc. (see e.g. FIGS. 1G and 20A); movement from the fully closed position to the fully open position may require force/effort to slide the door horizontally to overcome the force/effect of friction, etc. (see e.g. FIGS. 1C-1D and 20A) and then continued movement to the fully opened position may require relatively less force/effort to slide the door vertically as the force/effect of mass/gravity assists movement of the door toward and into the fully opened position (see e.g. FIGS. 1D-1E and 20A). As indicated schematically and representationally in FIG. 20A, the force/effect of the mass/gravity of the door/assembly in movement to the vertical fully opened/stowed position may overcome other forces present such that no other forces are required for continued movement of the door into the fully opened/stowed position (e.g. creating a potential uncontrolled/run-away condition that may not be desirable). As indicated schematically in FIGS. 20A, with the door/assembly the force/effort required by the vehicle occupant to move the door may be outside of a desired effort range (e.g. requiring additional assisting/lifting force/effort to move from the fully open position and requiring restraining/braking force/effort to prevent the run-away condition to move the door to the fully-opened position).

As indicated schematically and representationally in FIGS. 1B-1G, 2A-2C, 11 and 20B, the component may comprise a mechanism (shown as a spring mechanism SM) configured to apply a force to the door/cover. See also FIGS. 3A-3C, 4A-4C, 5A-5C, 6, 7A-7C, 8A-8C, 9A-9C, 10, 12A-12C, 13A-13C, 14A-14C, 15, 16A-16C, 17A-17C, 18A-18C and 19 (e.g. component/assembly comprising door/cover operable by effort/force applied by vehicle occupant and with mechanism to move between open/closed positions).

As indicated schematically and representationally in FIGS. 6, 15 and 20B, the door/assembly may be configured so that movement of the door from the closed position toward the open position may comprise (a) a zone of movement unassisted by the force from the mechanism and assisted by the force from the occupant to slide the door toward the open position and (b) a zone of movement restrained by the force from the spring mechanism as the door moves to the open position. See also FIGS. 3A-3C, 4A-4C, 5A-5C and 12A-12C, 13A-13C, 14A-14C (cover/door of component/assembly shown schematically and representationally in movement from closed position A through intermediate/transition position B to open position C). As indicated schematically in FIGS. 6, 15 and 20B, with the door/assembly with mechanism (as configured, designed, tuned, etc.) the force/effort required by the vehicle occupant to move the door is within a desired effort range.

As indicated schematically and representationally in FIGS. 10, 19 and 20B, the door/assembly with mechanism may be configured so that movement of the door from the open position toward the closed position may comprise (a) a zone of movement assisted by the force from the mechanism and assisted by the force by the occupant to lift the door and (b) a zone of movement unassisted by the force from the mechanism and assisted by the force from the occupant to slide the door toward the closed position. See also FIGS. 7A-7C, 8A-8C, 9A-9C and 16A-16C, 17A-17C, 18A-18C (cover/door of component/assembly shown schematically and representationally in movement from open position A through the transition/intermediate point B to closed position C). As indicated schematically in FIGS. 10, 19 and 20B, with the door/assembly with mechanism (as configured, designed, tuned, etc.) the force/effort required by the vehicle occupant to move the door is within a desired effort range.

According to an exemplary embodiment as indicated schematically and representationally in FIGS. 20A-20C, the door/assembly for the component may be configured with a mechanism (such as a spring mechanism) designed so that the force/effort required from the occupant for movement is generally linear/constant across the range of motion from the fully-opened position to fully-closed position (e.g. regardless of direction of movement and through the transition position where the mechanism/spring is engaged and/or disengaged). See also FIGS. 6, 10, 15 and 19 (movement shown in generally horizontal lines). As indicated schematically and representationally in FIG. 20C, a component with a door without a mechanism (movement shown in broken lines with down-slope/up-slope segments beginning at transition approaching the fully-opened position) may provide a less-ideal performance with respect to force/effort from the vehicle operator than the component with door/assembly with the mechanism (movement shown in generally horizontal solid lines from fully-opened position through transition to fully-closed position). See also FIGS. 1B-1G, 2A-2C and 11.

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising:
a base comprising a compartment; and
a cover configured to move relative to the base in a closing direction from an open position to expose the compartment to a closed position to cover the compartment through an intermediate position;
wherein at least one of the cover or the base comprises a mechanism configured to bias the cover toward the intermediate position when the cover is in the open position;
wherein the mechanism is configured to push the cover in the closing direction.

2. The component of claim 1 wherein the mechanism comprises a spring mechanism.

3. The component of claim 2 wherein the spring mechanism comprises a coil spring.

4. The component of claim 1 wherein the cover comprises a front edge and a rear edge; wherein the mechanism is configured to push the rear edge of the cover in the closing direction.

5. The component of claim 1 wherein the cover is configured to separate from the mechanism as the cover moves from the intermediate position toward the closed position.

6. The component of claim 1 wherein the cover comprises a front portion and a rear portion; wherein the front portion of the cover comprises a tab; wherein the mechanism is configured to push the tab at the front portion of the cover in the closing direction.

7. The component of claim 1 wherein the mechanism comprises a tab and the cover comprises a tab configured to engage the tab of the mechanism.

8. The component of claim 1 wherein the base comprises a structure comprising a first sidewall and a second sidewall to define the compartment and the mechanism is installed at at least one of the first sidewall and the second sidewall;
wherein the mechanism comprises a tab extending from the at least one of the first sidewall and the second sidewall to engage the cover.

9. The component of claim 1 wherein the base comprises a structure comprising a first sidewall and a second sidewall to define the compartment and the mechanism is installed at at least one of the first sidewall and the second sidewall;
wherein the cover comprises a tab extending into at least one of the first sidewall and the second sidewall to engage the mechanism.

10. The component of claim 1 wherein the component comprises at least one of (a) a vehicle trim component, (b) a console, (c) a floor console, (d) a center console, (e) a storage compartment, (f) an arm rest; and
wherein the cover comprises at least one of (a) a door, (b) a tambour door, (c) a shade, (d) a blind, (e) a roller blind.

11. A component for a vehicle interior comprising:
a base comprising a compartment; and
a cover configured to move relative to the base in a closing direction from an open position to expose the compartment to a closed position to cover the compartment through an intermediate position;
wherein at least one of the cover or the base comprises a mechanism comprising a spring configured to extend as the cover moves from the intermediate position toward the open position.

12. The component of claim 11 wherein the mechanism is configured to bias the cover toward the intermediate position when the cover is in the open position.

13. The component of claim 11 wherein the cover comprises a front edge and a rear edge; wherein the rear edge of the cover is configured to extend the spring.

14. The component of claim 11 wherein the base comprises the mechanism and wherein the cover is configured to initiate contact with the mechanism at the intermediate position as the cover moves from the closed position toward the open position.

15. The component of claim 11 wherein the mechanism comprises a tab and the cover comprises a tab configured to engage the tab of the mechanism.

16. A component for a vehicle interior comprising:
a base comprising a compartment; and
a cover configured for movement relative to the base from an open position to expose the compartment to a closed position to cover the compartment through an intermediate position;
wherein at least one of the cover or the base comprises a mechanism configured to (a) increase a force to move the cover from the intermediate position toward the open position and (b) reduce a force to move the cover from the open position to the intermediate position.

17. The component of claim 16 wherein the mechanism comprises a spring mechanism comprising a coil spring.

18. The component of claim 16 wherein the mechanism comprises a spring configured to (a) extend as the cover moves from the intermediate position toward the open position; (b) compress as the cover moves from the open position toward the intermediate position.

19. The component of claim 16 wherein the mechanism comprises a tab and the cover comprises a tab configured to engage the tab of the mechanism.

20. A vehicle interior component for a vehicle configured to be operated by a force provided by an occupant comprising:
a base;
a cover configured for movement along a guide between a closed position and an open position to allow access into the base;
a spring mechanism configured to apply a force to the cover;
wherein the cover is configured so that movement of the cover from the open position toward the closed position comprises (a) a zone of movement assisted by the force from the spring mechanism and assisted by the force by the occupant to lift the cover and (b) a zone of movement unassisted by the force from the spring mechanism and assisted by the force from the occupant to slide the cover toward the closed position;
wherein the cover is configured so that movement of the cover from the closed position toward the open position comprises (a) a zone of movement unassisted by the force from the spring mechanism and assisted by the force from the occupant to slide the cover toward the open position and (b) a zone of movement restrained by the force from the spring mechanism as the cover moves to the open position.
